(19) United States
(12) Patent Application Publication
(10) Pub. No.: US 2009/0063517 A1
(43) Pub. Date: Mar. 5, 2009

(54) User interfaces for scoped hierarchical data sets

(75) Inventors: Dawn Wright, Seattle, WA (US); Aaron Jasinski, Renton, WA (US); Samuel Wan, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/897,804

(22) Filed: Aug. 30, 2007

(51) Int. Cl. G06F 17/30

(52) U.S. Cl. 707/100; 707/E17.001

(57) ABSTRACT

One or more hierarchical scopes may be applied to various portions of a hierarchical data set to represent a logical grouping of various nodes in the hierarchy. Various user interfaces may be devised to navigate within such a scoped hierarchical data set, such as a scoped treeview that limits the viewed portion of the tree to the hierarchical scope and/or a scoped breadcrumb list containing an aggregated breadcrumb for the nodes sharing a scope to condense the breadcrumb list. Several embodiments of user interface components featuring such scoped treeviews and/or scoped breadcrumb lists and having various advantages are presented, as well as a few contexts for applying such scoped treeviews and/or scoped breadcrumb lists.

### BACKGROUND

Many areas of computing involve hierarchically organized data sets, as well as techniques for display and navigation through such data sets. A hierarchically organized set of such data items, also known as nodes, may be organized with one or more items at the topmost level, known as root nodes. Each node may contain any number of subordinate items, known as child nodes, which may in turn contain any number of subordinate items, etc. A node may also contain no child nodes, therefore serving as a leaf node. This organizational structure provides for a hierarchy of containment, where each node except for the root node(s) is contained within one higher-level node (known as a parent node.)

Hierarchical data organization may be used in several contexts. As one example, data stored in a format complying with an Extensible Markup Language (XML) schema is organized hierarchically, such that the XML data set contains at most one root node, and each data item except for the root node is contained within exactly one higher-level XML data item. In this example, containment represents nesting, which leads to a fully nested, strictly hierarchical data set.

Hierarchical data sets are often displayed through a treeview graphical user control, in which the individual nodes may be opened or closed to show or hide (respectively) the child nodes contained therein. An exemplary treeview is illustrated in FIGS. 1A-1B, each presenting a treeview of the same hierarchical data set in two different view states. FIG. 1A depicts the hierarchical data set 10 as containing a root node 12, Node A, that solely comprises the topmost level of the hierarchy, and that directly or indirectly contains all of the other nodes. For instance, Node A 12 directly contains Node B 14, Node C 16, Node F 22, and Node K 32, which together comprise the second level of the hierarchy. Node C 16 further contains Node D 18 and Node E 20, while Node F 22 further contains Nodes G 24, H 26, and J 30, and Node H 26 further contains Node I 28.

Treeview user controls may be used to display very large hierarchical data sets comprising millions of nodes, but displaying all of the nodes would be cumbersome for user navigation. The treeview therefore allows each node to be displayed in an open or closed state, where a node in an open state (denoted by a “−” sign) is shown with all of the child nodes, while a node in a closed state (denoted by a “+” sign) is shown with its child nodes hidden. The open or closed state of a node in the treeview may be toggled by the user (e.g., by clicking on the “+” or “−” symbol to the left of the node with a pointing device, such as a mouse.) The treeview depicted in FIG. 1B illustrates the same data set as the treeview of FIG. 1A, but with Node C 16, Node H 26, Node J 30, and Node K 32 shown in a closed state (thereby hiding Nodes D 18 and E 20 contained within Node C 16, and Node I 28 contained within Node H 26.) The hierarchical data set illustrated by the treeview of FIG. 1B still contains Nodes D 18, E 20, and I 28, but these child nodes are hidden in the current state of the treeview, and may be shown again by opening the respective parent nodes.

The hierarchical organization of the treeview enables the description of nodes according to the respective paths traversed to reach them. For instance, Node H 26 in FIG. 1A may be described as the child node of Node F 22, which is in turn the child node of Node A 12. In reverse direction, Node H 26 may be reached by traversing the hierarchical data set illustrated in FIG. 1A by beginning at Node A 12, navigating (among the child nodes of Node A 12) to Node F 22, and navigating (among the child nodes of Node F 22) to Node H 26. This sequence forms a hierarchical path of Node A 12: Node F 22: Node H 26, which may be used to describe the organization of Node H 26 within the hierarchical data set.

When a user is navigating through a hierarchical data set, this sequence may also be presented as a breadcrumb list, e.g., as the hierarchical series of nodes through which the user has navigated to reach the current node. FIG. 1C illustrates the breadcrumb list for each node in the hierarchical data set of FIG. 1A. In the exemplary breadcrumb list 40 of FIG. 1C, when each node 42 of the hierarchical data set is selected, it is associated with a breadcrumb list 44 containing breadcrumbs 46 representing each location within the path from a root node of the hierarchical data set to the selected node 42. In the exemplary breadcrumb lists 44 of FIG. 1C, the breadcrumbs 46 are displayed in order from the root node to the selected node. The displayed breadcrumb lists 44 therefore display for the user the path taken through the hierarchical data set to reach the selected node 42. Moreover, in some implementations, the breadcrumbs 46 of the breadcrumb lists 44 may be activated (e.g., by clicking on a breadcrumb with a pointing device, such as a mouse) to travel to the node represented by the activated breadcrumb (e.g., by causing a treeview displaying the same hierarchical data set to jump to the node represented by the activated breadcrumb.)

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The discussion herein pertains to the representation of hierarchical data sets through various user interfaces. Large hierarchies may be difficult to display or describe with treeviews and/or breadcrumb lists, since navigating to some nodes within the hierarchy may require deep navigation within a treeview and/or through long lists of breadcrumbs that present a cumbersome amount of information to a user. Accordingly, as described herein, hierarchical data sets may be “scoped” to facilitate more efficient navigation there-through. That is, nodes within a hierarchical data set may be grouped or otherwise conceptually related according to some desired criteria to establish one or more scopes. In one example, the portion of a hierarchical data set displayed in a treeview may be limited based on the scope of the selected node, thereby presenting the hierarchical data set as apportioned by scope. In another example, nodes of a scope may be aggregated into a single breadcrumb of a breadcrumb list, thus effectively shortening the breadcrumb list and making it more navigable.

To the accomplishment of the foregoing and related ends, the following description and annexed drawings set forth certain illustrative aspects and implementations. These are indicative of but a few of the various ways in which one or more aspects may be employed. Other aspects, advantages, and/or novel features may become apparent from the following detailed description when considered in conjunction with the annexed drawings.

### DESCRIPTION OF THE DRAWINGS

FIG. 1A-1B are illustrations of exemplary treeview user interface components for an exemplary non-scoped hierarchical data set.

FIG. 1C is a table of breadcrumb lists for various nodes in the exemplary non-scoped hierarchical data set illustrated in FIGS. 1A-1B.

FIG. 2A is a flowchart illustration depicting an exemplary method.

FIG. 2B is a flowchart illustration depicting another exemplary method.

FIG. 3A is an illustration of an exemplary scoped hierarchical data set.

FIG. 3B is a set of exemplary scoped treeviews for the exemplary scoped hierarchical data set illustrated in FIG. 3A.

FIG. 3C is a table of breadcrumb lists for various nodes in the exemplary scoped hierarchical data set illustrated in FIG. 3A.

FIG. 4A is an illustration of another exemplary treeview user interface component for another exemplary scoped hierarchical data set.

FIG. 4B is a set of exemplary scoped treeviews for the exemplary scoped hierarchical data set illustrated in FIG. 4A.

FIG. 4C is another set of exemplary scoped treeviews for the exemplary scoped hierarchical data set illustrated in FIG. 4A.

FIG. 4D is a table of exemplary breadcrumb lists for various nodes in the exemplary scoped hierarchical data set illustrated in FIG. 4A.

FIG. 4E is another table of exemplary breadcrumb lists for various nodes in the exemplary scoped hierarchical data set illustrated in FIG. 4A.

FIG. 4F is yet another table of exemplary breadcrumb lists for various nodes in the exemplary scoped hierarchical data set illustrated in FIG. 4A.

FIG. 5A is a table of exemplary hierarchical data scopes and viewer components for accessing nodes within the exemplary hierarchical data scopes.

FIG. 5B is an illustration of an exemplary scoped treeview user interface component for yet another exemplary scoped hierarchical data set.

FIG. 5C is a table of exemplary breadcrumb lists for various nodes in the exemplary hierarchical data set illustrated in FIG. 5B and the viewer component associated with each node in accordance with the table of FIG. 5A.

FIG. 5D is a table of exemplary breadcrumb lists for various nodes in the exemplary scoped hierarchical data set illustrated in FIG. 5B.

FIG. 6 is a component diagram illustrating an exemplary system.

FIG. 7 is an illustration of an exemplary integrated development environment comprising a breadcrumb list such as disclosed herein.

FIG. 8 is an illustration of an exemplary computer-readable medium comprising processor-executable instructions configured to perform a method such as disclosed herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form to facilitate describing the claimed subject matter.

This disclosure relates to techniques for representing scoped hierarchical data sets, and particularly to scoped treeviews and/or scoped breadcrumb lists for navigating through scoped hierarchical data sets. An unscoped treeview control may be associated with a very large hierarchical data set, but the amount of information contained therein may be cumbersome for the control. In particular, navigating through hierarchical data sets having many levels may be very time-consuming, since the user may have to manage the opening and closing of many nodes in an unscoped treeview in order to reach a low-level node. Similarly, an unscoped breadcrumb list for a low-level control may grow onerously long. The display of multiple levels of depth in an unscoped breadcrumb list may overwhelm a user with too much information. It can be appreciated that these drawbacks may diminish the navigational utility of user interface components, and this may be exacerbated on devices with small displays, such as smart cellular phones and ultramobile PCs (UMPCs), which feature scaled-down LCD screens for enhanced portability.

Implementing scoped treeviews and/or scoped breadcrumb lists to display scoped hierarchical data sets as described herein facilitates efficient data navigation and/or management. For example, in a scoped hierarchical data set various levels of the hierarchy are linked for aggregation. With regard to a scoped treeview user interface, the view is generally restricted to the nodes of a particular (selected) scope and child nodes thereof. If a user selects a node of a particular conceptual section (e.g., a scope) of the hierarchical data set, the “scoped treeview” for this “scoped” hiererachical data set is redrawn and illustrated with the scope used for the root of the tree (e.g., as the “root scope.”) Accordingly, the treeview may be redrawn with the scope shown as the root of the tree, e.g., with the treeview limited to the nodes comprising the scope and the child nodes thereof. The presentation of the treeview is therefore refocused on the conceptually related nodes and the child nodes thereof; the nodes above and/or outside of the conceptually related nodes (e.g., scope) may be omitted from the displayed treeview until and unless the user navigates out of the current scope. Similarly, with regard to a scoped breadcrumb list, respective breadcrumbs corresponding to nodes of a particular hierarchical scope may be aggregated into a single breadcrumb within the list. Moreover, a breadcrumb comprising many aggregated breadcrumbs (of the same scope) (e.g., where a user has navigated deeply into the scoped hierarchical data set) may be collapsed to further simply the user interface.

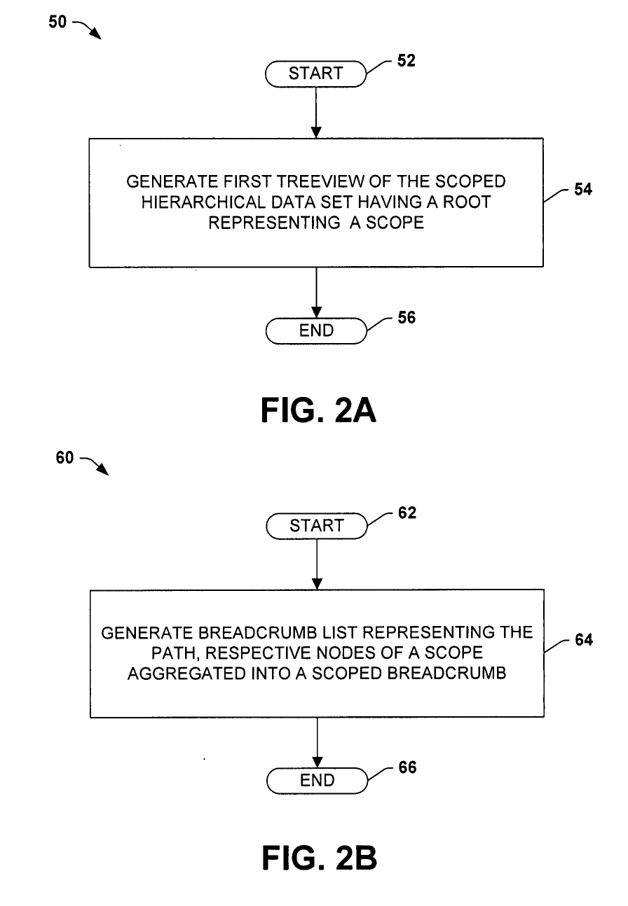

FIG. 2A presents a flowchart illustrating an exemplary method in accordance with principles of scoped treeviews for scoped hierarchical data sets. This figure illustrates a method 50 of representing a scoped hierarchical data set that begins at 52 and involves generating a first scoped treeview of the scoped hierarchical data set having a root representing the scope 54. Having generated this scoped treeview, the method 50 ends at 56.

FIG. 2B presents a flowchart illustrating an exemplary method in accordance with principles of scoped breadcrumb lists for scoped hierarchical data sets. This figure illustrates a method 60 of identifying a path from a root node to a selected node in a scoped hierarchical data set, the path having at least one scope. The exemplary method 60 begins at 62 and involves generating a breadcrumb list representing the path, respective nodes of a scope aggregated into a scoped breadcrumb 64. Having generated this breadcrumb list, the method 60 ends at 66.

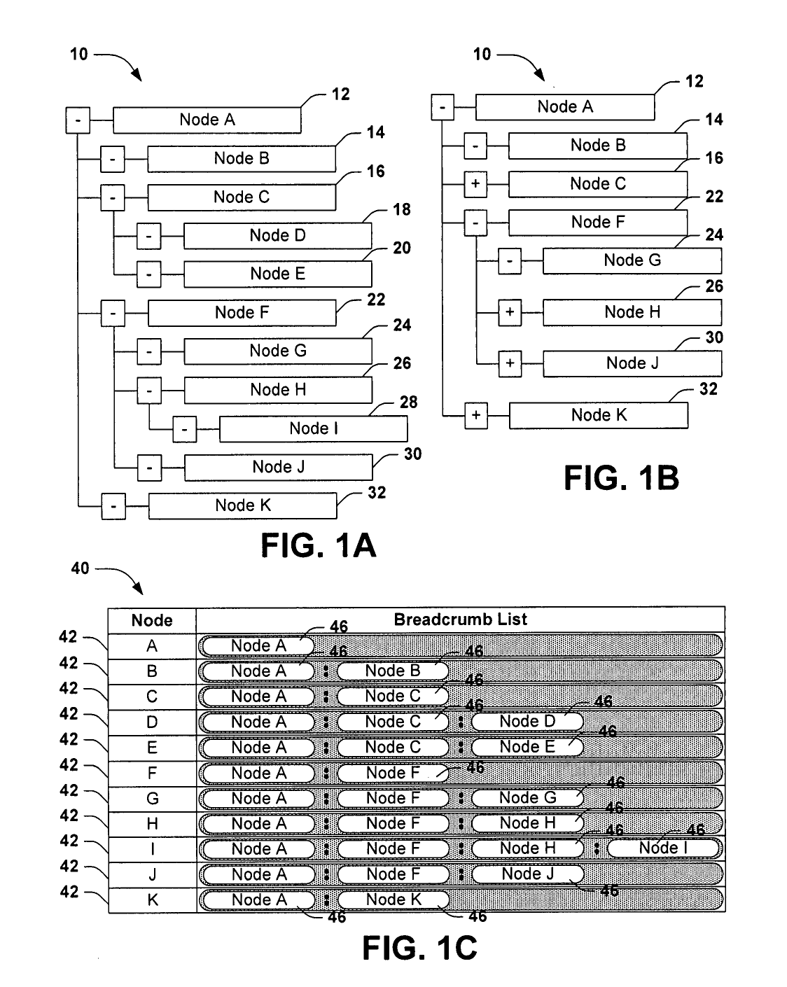

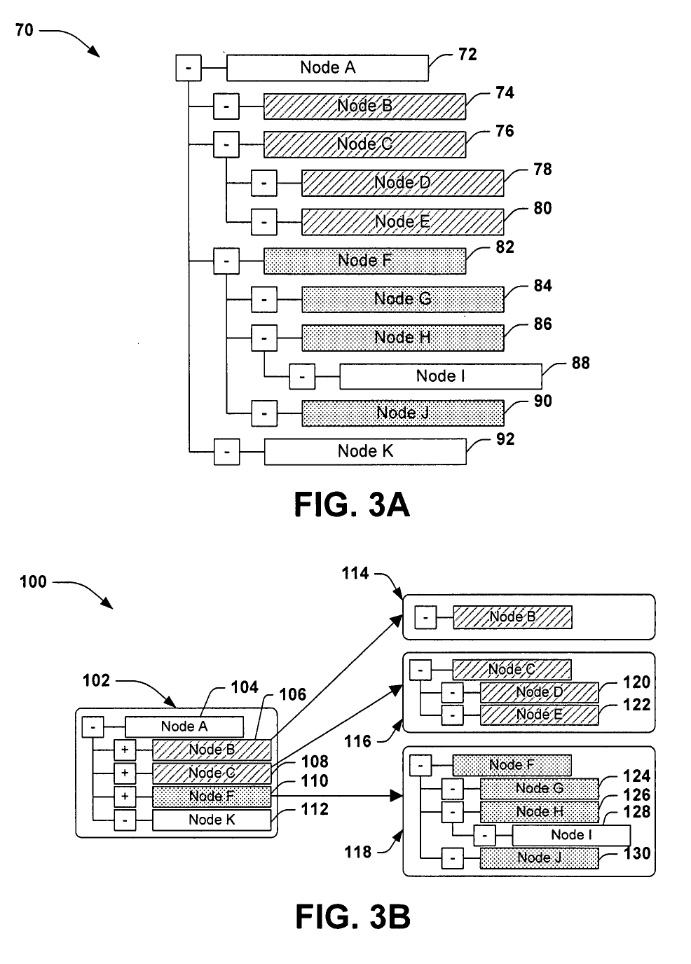

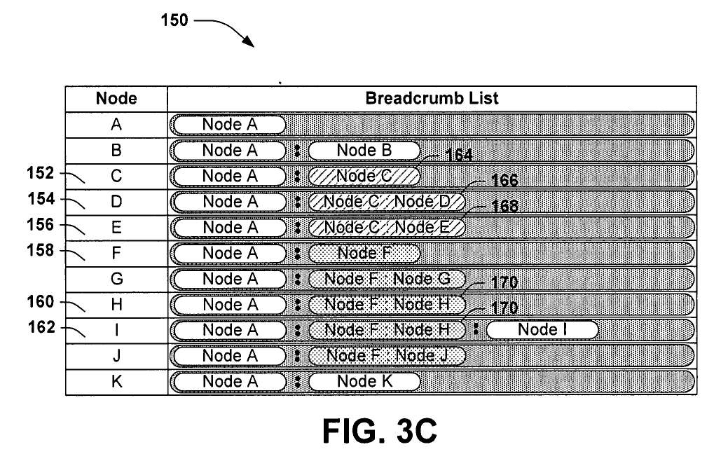

FIG. 3A illustrates an exemplary scoped hierarchical data set to which these exemplary methods may be applied. This exemplary scoped hierarchical data set 70 contains the same organization of nodes as the non-scoped hierarchical data set 10 of FIG. 1A, but some nodes of the former hierarchical data set have been grouped into hierarchical scopes. Two hierarchical scopes are illustrated therein: one scope comprising the second-level nodes B 74 and C 76, and the third-level nodes D 78 and E 80 within node C 76; and one scope comprising the second-level node F 82, and the third-level nodes G 84, H 86, and J 90. The scopes are depicted with different shading for illustrative purposes, but it will be appreciated that the hierarchical scopes are a conceptual relationship; while the user interfaces depicting scoped hierarchies might incorporate such shading, the visual presentation is not a requisite element of this technique. It will also be noted from FIG. 3A that the child nodes of a particular node are not necessarily of the same scope. For example, Node A 72 contains as child nodes both Nodes B 74 and C 76 (of one scope), Node F 82 (of another scope), and Node K 92 (unscoped.) It will also be noted that a node associated with a scope may contain child nodes associated with another scope, or with no scope. For example, Node D 78 could be associated with the scope of Nodes F 82, G 84, H 86, and J 90, instead of the scope of Nodes B 74, C 76 and E 80. Similarly, although Node I 88 is unscoped in the illustrated example, Node I 88 could have a scope that is different from the scope of Node H 86 (which has the same scope as Nodes F 82, G 84, and J 90 in the illustrated example.) Finally, it will be noted that it is advantageous for each scope to comprise at least one pair of nodes having a parent/child hierarchical relationship (e.g., Node E 80 to Node C 76) to permit the aggregation of such nodes in a scoped breadcrumb.

FIG. 3B illustrates the application of a scoped treeviewing method, such as the scoped treeviewing method 50 illustrated in FIG. 2A, to the exemplary scoped hierarchical data set 70 of FIG. 3A to produce, for each hierarchical scope in the hierarchical data set, a scoped treeview 100. The first scoped treeview 102 is illustrated as the scoped treeview for Node A 104, which is the root node of the hierarchical data set, and is unscoped. For each of the scoped child nodes 106, 108, 110 of Node A 104, a corresponding scoped treeview 114, 116, 118 is illustrated, wherein the scoped treeview for each such scoped child node is rooted at the child node. Selecting Node B 106, for example, produces a scoped treeview 114 that is rooted in Node B 106, and includes the child nodes of Node B 106 (which number zero in the illustrated example as Node B 106 is a leaf node.) Because this scoped treeview 114 is rooted at Node B 106, it does not include parent Node A 104, nor any of the other child nodes of Node A 104. Similarly, navigating to Node C 108 produces a treeview 116 of Node C 108 and its child nodes 120, 122. Navigating within this scope (e.g., to Nodes D 120 and E 122) produces the same scoped treeview 116 rooted at Node D 120, since Node D 120 shares a hierarchical scope with Nodes D 120 and E 122. Likewise, navigating to Node F 110 produces a treeview 118 of Node F 110 and its child nodes 124, 126, 130. Navigating within this scope (e.g., to Nodes G 124, H 126, and J 130) produces the same scoped treeview 118 rooted at Node F 110, since Node F 110 shares a hierarchical scope with Nodes G 124, H 126, and J 130. By contrast, navigating from Node A 104 to Node K 112 does not produce a separate scoped treeview (e.g., a different treeview from the treeview 102 rooted at Node A 104) because unscoped Node K 112 is not of a different scope than unscoped Node A 104. Comparing FIG. 3B with FIG. 3A illustrates the improved efficiency of the scoped treeviews 100 in displaying the scoped hierarchical data set 70.

FIG. 3C illustrates the application of a scoped breadcrumbing method, such as illustrated in FIG. 2B, to the exemplary scoped hierarchical data set 70 of FIG. 3A to produce, for each node in the hierarchical data set, an exemplary breadcrumb list having scoped breadcrumbs. In the table of breadcrumb lists 150 illustrated herein, the breadcrumb list for each node advantageously incorporates the hierarchical scoping of nodes in the data set. Because Nodes C 152, D 154, and E 156 share a hierarchical scope, the breadcrumbs that reference these nodes are aggregated to produce a scoped breadcrumb. Thus, the breadcrumb list for Node D 154 features a scoped breadcrumb 166 that comprises both Nodes C 152 and D 154, and the breadcrumb list for Node E 156 features a scoped breadcrumb 168 that comprises both Nodes C 152 and E 156. As noted in the discussion of FIG. 3A, a node having a scope may contain a child node of a different scope or no scope. For example, Node I 162 is an unscoped child node of Node H 160 in the illustrated example, which shares a scope with Node F 158; therefore, Nodes F 158 and H 160 are aggregated into one scoped breadcrumb 170, while Node I 162 is presented as an unscoped breadcrumb in the breadcrumb list. It will be appreciated that this same presentation would be rendered if Node I 162 were of a different scope than Nodes F 158 and H 160 (rather than just being unscoped.)

A scoped treeview and/or scoped breadcrumb list generated as described herein may be displayed to a user for navigating through a scoped hierarchical data set. In one embodiment, respective hierarchical scopes are associated with a distinctive visual style, and displaying the scoped treeview or breadcrumb list may comprise displaying at least one scoped treeview node or scoped breadcrumb, respectively, according to the visual style of the associated hierarchical scope. A scoped treeview node or scoped breadcrumb comprising nodes within a particular scope may then be displayed for the user according to the visual style of the scope, which may inform the user as to the nature of the hierarchical scope that the treeview node or the breadcrumb (and the scoped nodes comprised therein) represents. As one example, the distinctive visual style may represent a color that is conceptually associated with the scope, and the scoped treeview nodes or breadcrumbs comprising nodes sharing a hierarchical scope may be displayed in the color of the shared scope. As another example, as illustrated in FIGS. 3A-3C, the scoped treeview nodes 100 illustrated in FIG. 3B and the scoped breadcrumbs presented in FIG. 3C are illustrated as having the same shading as the hierarchical scopes 70 illustrated in FIG. 3A. In another embodiment, the nodes representing a hierarchical scope (e.g., in an aggregated scoped breadcrumb or in a scoped treeview that has a different root scope) may be displayed according to the name of the scope. Thus, a hierarchical scope named “User Control 1”, which may comprise components of a user control in an integrated development environment, for example, may be represented as an aggregated breadcrumb displayed with a “User Control 1” label (perhaps even omitting the names of the nodes comprising the aggregated breadcrumb), or as a node in a scoped treeview bearing a “User Control 1” label (where the nodes of the hierarchical scope are hidden until the user navigates into this hierarchical scope.) Those of ordinary skill in the art may be capable of choosing many such visual styles while practicing the techniques discussed herein.

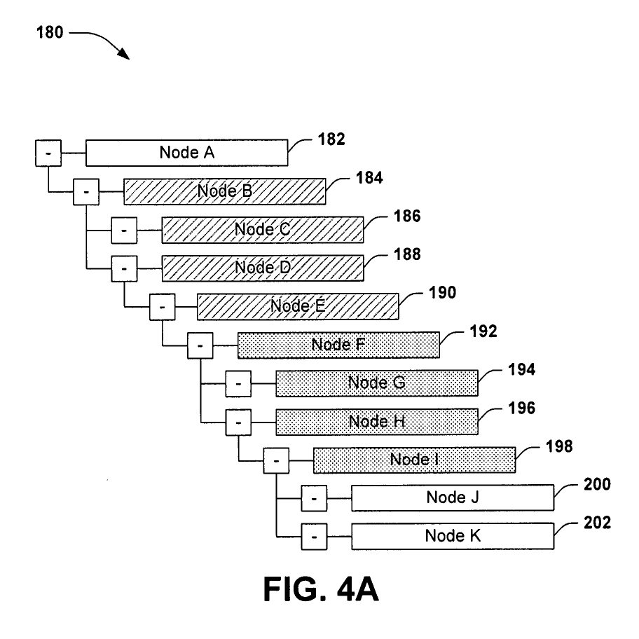

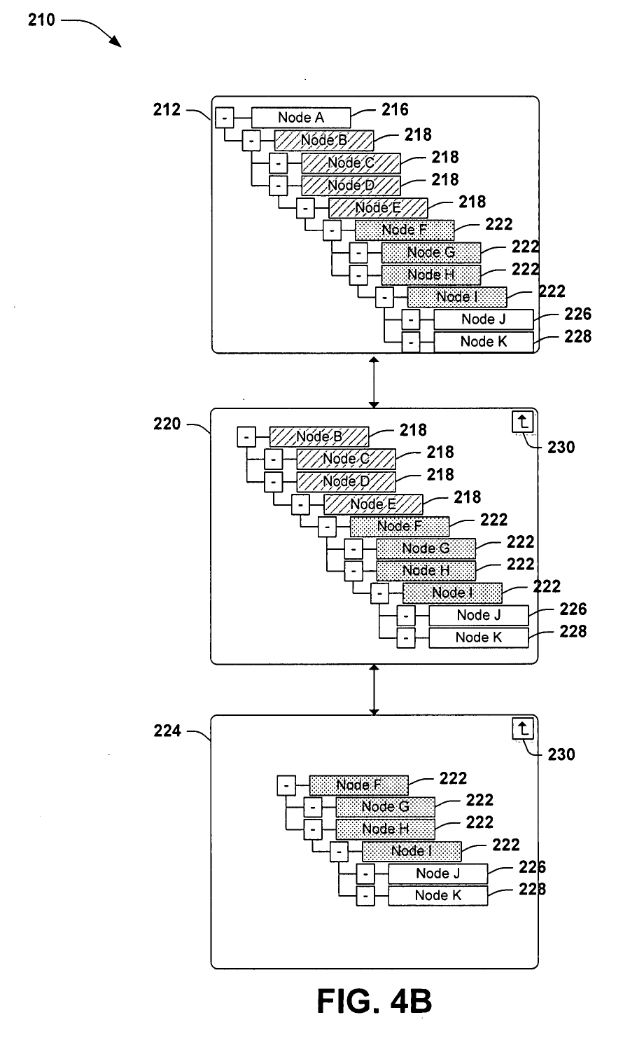

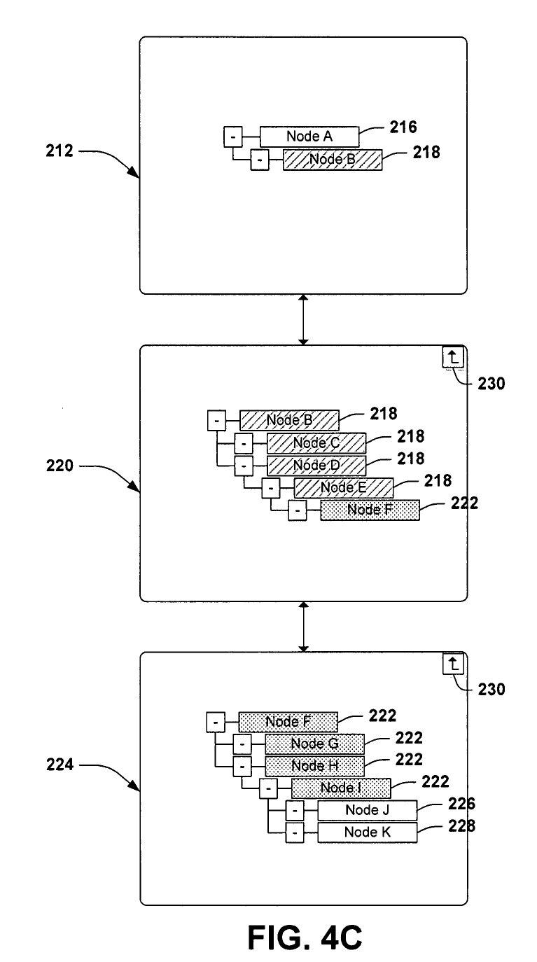

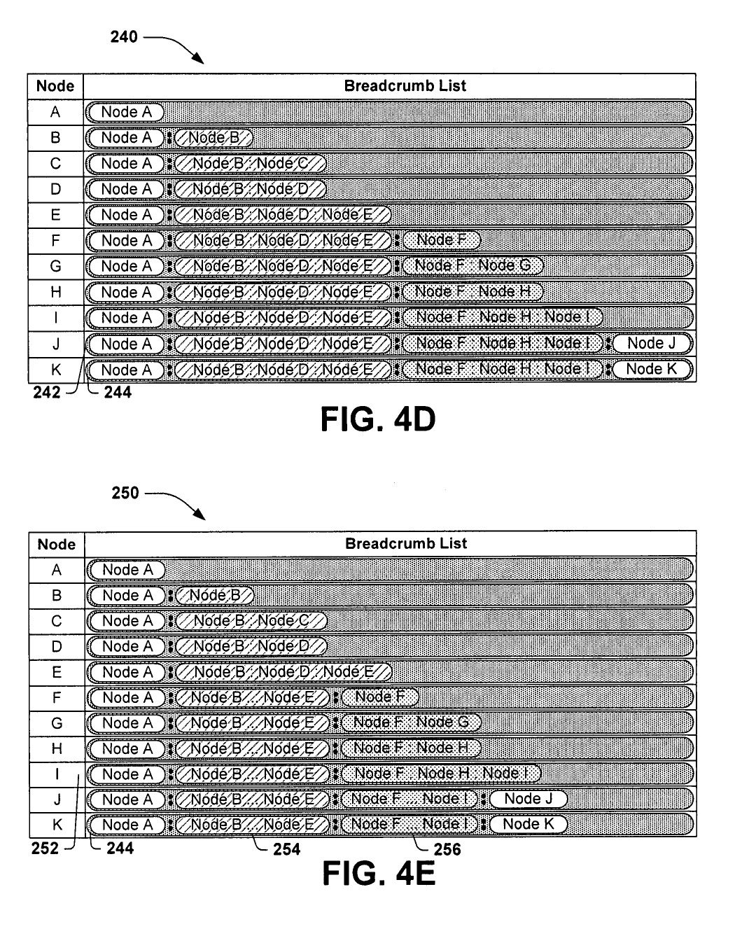

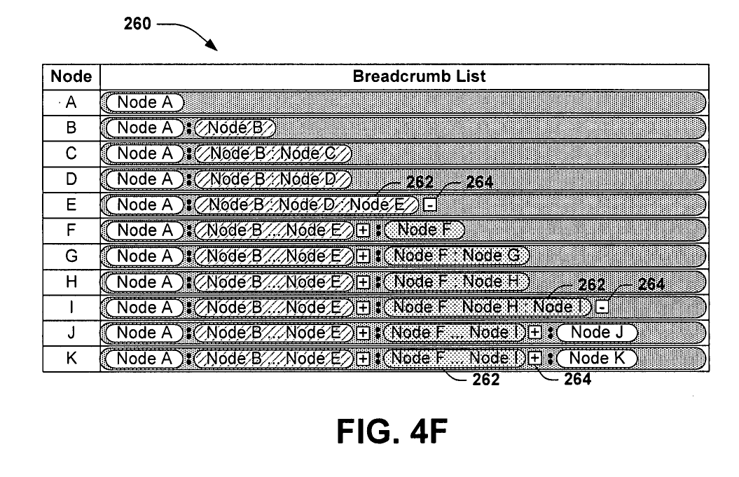

FIG. 4A illustrates another exemplary scoped hierarchical data set 180, which is deeply nested (e.g., Nodes J 200 and K 202 are eight levels deep in the hierarchy.) An unscoped treeview for navigating this deeply nested hierarchical data set 180 might require extensive traversal of the treeview to reach desired nodes, and might similarly require an extensive number of unscoped breadcrumbs to describe the path from the root node to the more deeply nested nodes. This exemplary scoped hierarchical data set 180 serves as the basis for the exemplary embodiments of scoped treeviews an scoped breadcrumb lists illustrated in FIGS. 4B-4F.

FIGS. 4B and 4C illustrate two alternative sets of scoped treeviews for representing the scoped hierarchical data set 180 of FIG. 4A. The root Node A 182 of the scoped hierarchical data set 180 is illustrated in FIG. 4B in a first treeview 212 having Node A as the root node of the treeview 214. This treeview also contains child Nodes B, C, D, and E that comprise a first hierarchical scope 218. Upon receiving user input representing selection of a node in the first hierarchical scope 218, the system generates a second scoped treeview 220 of the scoped hierarchical data set 180 having a root representing the scope of the selected node. Since this second scoped treeview 220 is rooted in the first hierarchical scope 218 (and particularly at Node B 184, as this is the highest node in the first hierarchical scope), the scoped treeview 220 does not include parent Node A 182. By extension, selecting (e.g., navigating to) any of Nodes F through I together comprising the second hierarchical scope 222, in either the first scoped treeview 212 or the second scoped treeview 220 presents the third scoped treeview 224, which is rooted at node F 192, as the root of the second hierarchical scope. Again, since this third scoped treeview 224 is rooted at Node F 192 (corresponding to the second hierarchical scope), this scoped treeview includes neither the unscoped Node A 182 nor Nodes B through E 184, 186, 188, 190 of the first hierarchical scope.

The scoped treeviews of FIG. 4B illustrate some additional aspects of scoped treeviews that may vary by implementation. As one example, respective hierarchical scopes are associated with a distinctive visual style, and the scoped nodes of the scoped treeviews are displayed in the distinctive visual style of the represented hierarchical scope. In the example of FIG. 4B, the distinctive visual style comprises distinctive hashing for the first hierarchical scope 218 and distinctive shading for the second hierarchical scope 222. Other visual styles (e.g., distinctive colors) may be devised and displayed in accordance with the techniques described herein.

As another example, the scoped treeviews that are not rooted at a root node of the scoped hierarchical data set 180 (e.g., the treeviews presenting views other than the topmost view of the hierarchical data set 180) include a scope departure control 230, in the form of an “up” arrow icon. The purpose of the scope departure control 230 is to enable the user to navigate upward out of the current scope. This functionality is otherwise unavailable in some scoped treeviews 220, 224 of the scoped hierarchical data set 180; because the parent nodes are omitted from the display, the user cannot select them to move upward in the hierarchical data set. Thus, the scope departure control 230 is included, and upon receiving user input representing activation of the scope departure control (e.g., clicking the icon with a pointing device, such as a mouse), the scope departure control 230 causes the scoped treeview to traverse upward one (or more) hierarchical scopes. For example, activating the scope departure control 230 from the third scoped treeview 224 of FIG. 4B causes an upward traversal to the second scoped treeview 220. Those of ordinary skill in the art may devise variations of the navigational component of the scoped breadcrumbs. As one example, a breadcrumb list may be included with the scoped treeview to represent the path from a root node to the root scope of the scoped treeview, and to enable the user to navigate upward and out of the hierarchical scope.

As a third example, in each scoped treeview of FIG. 4B, all child nodes of the nodes comprising the current hierarchical scope are illustrated. An alternative embodiment is illustrated in FIG. 4C, in which, by contrast with FIG. 4B, the scoped treeview omits the child nodes of each node having a different hierarchical scope than the root scope. This omission is different from the opening and closing of nodes in the treeview that (respectively) shows or hides its child nodes. Rather, in the alternative embodiment of FIG. 4C, the omitted nodes are not shown in the scoped treeview even when the parent nodes are opened. For example, in the second treeview 220 of FIG. 4C, the root scope is the hierarchical scope comprising Nodes B 184, C 186, D 188, and E 190 of the exemplary scoped hierarchical data set 180 of FIG. 4A. This second scoped treeview 220 also displays Node F 192, but since Node F 192 has a different hierarchical scope than the root scope, its child nodes (e.g., nodes are omitted from this scoped treeview. Selecting Node F 192 causes the system to display the third treeview 224, which includes Node F 192 and all of its child nodes. In this third treeview 224, the scope 222 of Nodes F 192, G 194, H 196, and I 198 is now the root scope. As such, child nodes of a scope different from the scope 222 of Nodes F-I would be omitted. Although no such Nodes are illustrated, it can be appreciated that the same may not be true for unscoped Nodes. For example, Nodes J 200 and K 202 are unscoped (as opposed to having different scope than the scope 222 of Nodes F-I) and thus are illustrated in the third treeview 224 of FIG. 4C.

FIGS. 4D illustrates a set of scoped breadcrumb lists 240 that may be used to represent a scoped hierarchical data set 180. Because the exemplary scoped hierarchical data set 180 of FIG. 4A is deeply nested, an unscoped breadcrumb list for Nodes J and K would require eight breadcrumbs to illustrate the full path. By contrast, the scoped breadcrumb lists 242, 244 for Nodes J 200 and K 202 are illustrated in FIG. 4D; due to the aggregation of nodes sharing a hierarchical scope into a scoped breadcrumb, the breadcrumb lists for Nodes J 242 and K 244 only require four breadcrumbs. The aggregation reflects the two hierarchical scopes of the exemplary hierarchy of FIG. 4A, where the first scope applies to Nodes B 184, C 186, D 188, and E 190, and the second scope applies to Nodes F 192, G 194, H 196, and I 198. It will again be noted that each scope is illustrated as having a distinctive visual style (e.g., hashing and/or shading) and that the scoped breadcrumbs are displayed with the corresponding style. Again, it will be noted that a variety of such distinctive visual styles may be devised (e.g., distinctive colors associated with the hierarchical scopes), and may be used in accordance with the concepts discussed herein.

FIGS. 4E and 4F illustrate two alternative embodiments of the scoped breadcrumb lists for the scoped hierarchical data set 180 presented in FIG. 4A. These embodiments 240, 250 include the concept of a collapsed view of one or more scoped breadcrumbs, so as to generate an even more condensed breadcrumb list representing the path to a node in the hierarchy. A collapsed view of a scoped breadcrumb displays fewer than all of the nodes in the scoped breadcrumb. For instance, a scoped breadcrumb representing a scope that spans four levels of a hierarchical data set may reference four nodes within the displayed breadcrumb, but this amount of information may more detailed than needed. Thus, this scoped breadcrumb may be displayed in a collapsed view, where only a few of the four nodes are displayed to provide a general indication of the nature of the hierarchical scope. It may be beneficial to display an indicator, such as an ellipsis, within the scoped breadcrumb to denote the inclusion of additional nodes that are hidden in the collapsed view.

FIG. 4E features one exemplary use of collapsed views of breadcrumbs 240, in which the collapsed view of the breadcrumbs comprises the highest-level node in the scoped breadcrumb and the lowest-level node in the scoped breadcrumb, along with an ellipsis to indicate that one or more intermediate-level nodes are hidden in the collapsed view of the scoped breadcrumb. For example, in the breadcrumb list 244 for Node K 202, the nodes of the breadcrumb list 244 that comprise the first hierarchical scope (Nodes B 184, D 188, and E 190) are aggregated into a first scoped breadcrumb 254 that is displayed in a collapsed view, displaying only the highest level Node B 184 and the lowest-level Node E 190. Similarly, the nodes of the breadcrumb list 244 that comprise the second hierarchical scope (Nodes F 192, H 196, and I 198) are aggregated into a second scoped breadcrumb 256 that is also displayed in a collapsed view, displaying only the highest level Node F 192 and the lowest-level Node I 198. Other such indicators may be devised, along with other techniques for displaying breadcrumbs in a collapsed view in accordance with the concepts discussed herein. It will be appreciated that some breadcrumbs may be displayed in a collapsed view, while other breadcrumbs may be displayed in an uncollapsed view. For example, the scoped breadcrumb containing the selected node may be shown in an uncollapsed state, while the other scoped breadcrumbs are shown in a collapsed state (such as in the breadcrumb path 252 for Node I 198.) Again, other techniques for selecting nodes for a collapsed view or an uncollapsed view may be devised in accordance with the concepts discussed herein.

FIG. 4F features another embodiment of breadcrumb lists 260 for scoped hierarchical data sets 180 that includes the concept of collapsed views of scoped breadcrumbs. This embodiment 260 features a manual collapsing aspect, wherein, upon receiving user input representing activation of a scoped breadcrumb, the collapsed view of the activated scoped breadcrumb is toggled. In this embodiment, each scoped breadcrumb 262 containing more than two is displayed with an indicator 264 of the collapsed or uncollapsed state of the scoped breadcrumb 262, and activating the indicator 264 (e.g., clicking on the indicator 264 with a pointing device, such as a mouse) toggles the collapsed or uncollapsed view of the scoped breadcrumb 262. The manual collapsing aspect of scoped breadcrumbs may be used alternatively or additionally with automatic collapsed or uncollapsed views of scoped breadcrumbs.

Another set of embodiments of scoped treeviews and/or scoped breadcrumb lists relates to the effect upon receiving user activation of a scoped treeview node and/or scoped breadcrumb. As one example, upon receiving user input representing activation of a treeview node or a node within a breadcrumb, the node may be presented in a user interface component. In one such embodiment, the activation of a node may simply display the organizational position of the node within the hierarchical data set (e.g., upon selecting a node in a breadcrumb list, the system may display a scoped treeview of the hierarchical data set with the focus set on the node activated in the breadcrumb list.) In another such embodiment, a user may use a pointing device, such as a mouse, to click on a node in the breadcrumb list, or on a node in the scoped treeview, and the system may respond by presenting the information contained in the node. As one example, the hierarchical data set may comprise a website having hierarchically organized pages, where each node in the hierarchical data set represents a page of the website, and where each node contains other nodes representing subordinate pages within the hierarchically organized website. Activating a node might thereby cause a viewer, such as a web browser, to display the page associated with the activated node. Moreover, the page so displayed might include a breadcrumb list to illustrate the path of pages in the website in which the currently viewed page is hierarchically located.

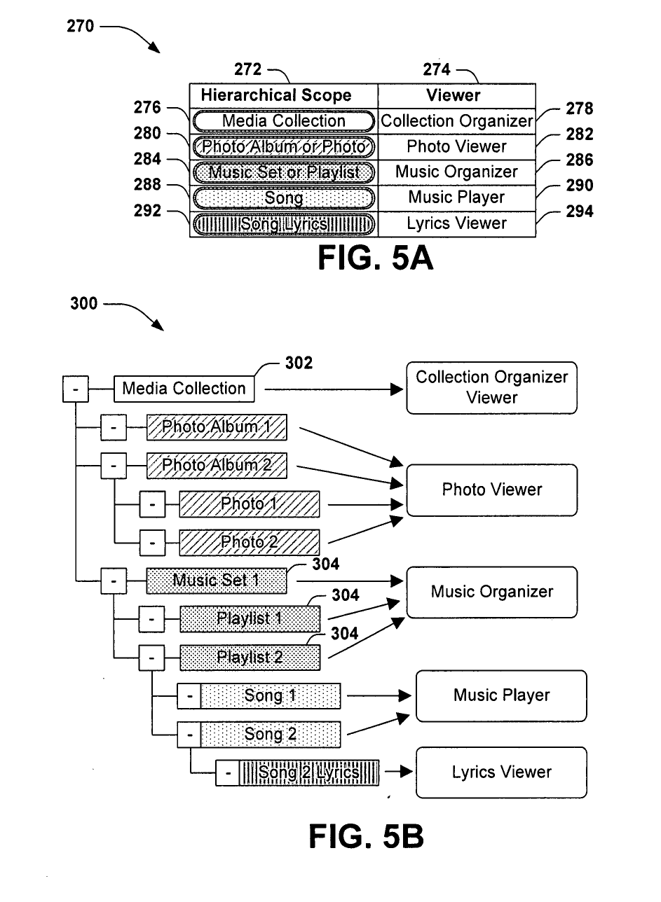

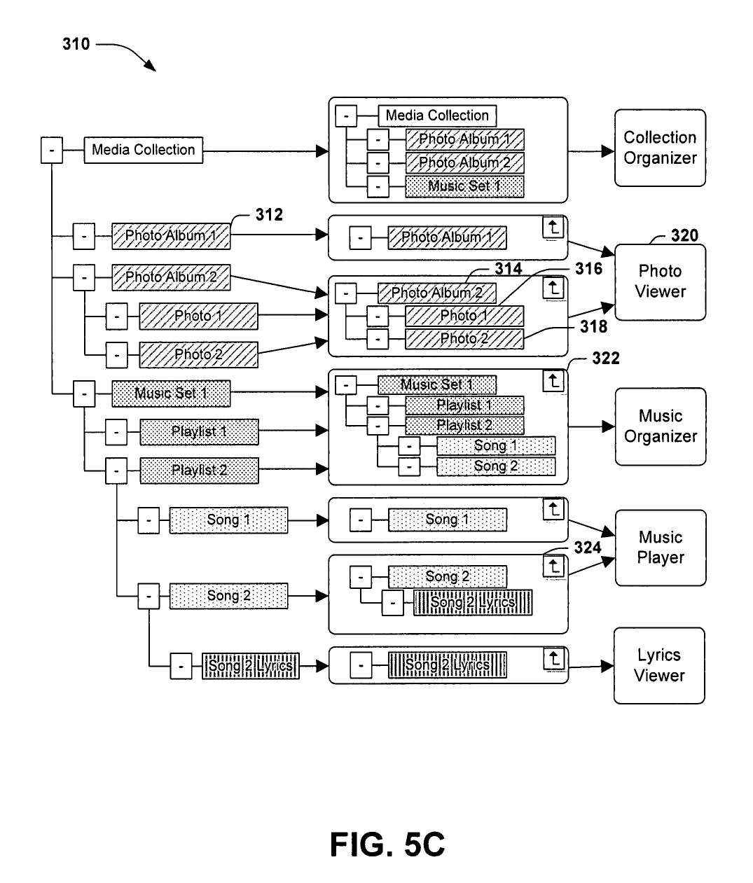

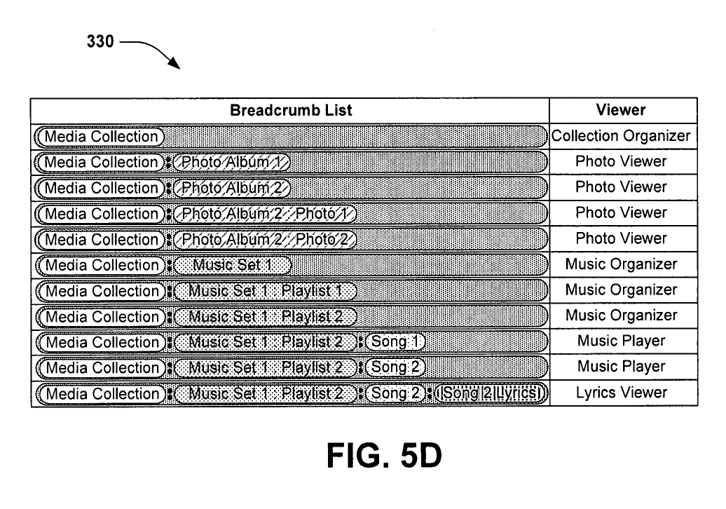

FIGS. 5A-5D present another embodiment of a scoped treeview and a scoped breadcrumb list that relate to the effect of activating a node in the hierarchical data set. In these exemplary embodiments, upon receiving user input representing activation of a node in a treeview or a breadcrumb in the breadcrumb list, the system displays the activated node in a user interface component. In one embodiment, the user interface component comprises a viewer configured to display the activated node. The user interface component may permit any of several forms of interaction with the data represented by the activated node; e.g., the system may simply display the contained information, or may allow the user to create, edit, or delete information for the selected node. In this manner, a hierarchical scope may be associated with a user interface component, such as an application, configured to view the data comprising nodes of the type associated with the hierarchical scope. The user may therefore work with the data organized in the hierarchical data set by activating nodes in the scoped treeview interface or the scoped breadcrumb list. It will be appreciated that “selecting” a node and “activating” a node may comprise two different forms of user input. For example, a node may be “selected” by clicking the node with a pointing device, such as a mouse, whereas the node may be “activated” by double-clicking the node with the pointing device.

FIG. 5A illustrates an exemplary set 270 of associations between hierarchical scopes 272 and viewers 274. For instance, a hierarchical scope 276 representing a media collection (e.g., the hierarchical data set identifying the contents of the media collection) may be associated with a collection organizer 278, which provides an interface for browsing and organizing the media collection. Another hierarchical scope 280 may be created to represent images, e.g., photo files and lists of photos comprising photo albums, and may be associated with a photo viewer application 282. A third scope 284 may be created to represent music sets and playlists, and may be associated with a music organizer application 286. A fourth scope 288 may be created to represent music files, and may be associated with a music player application 290. Finally, a fifth scope 292 may be created to represent song lyrics, and may be associated with a lyrics viewer 294.

FIG. 5B illustrates an exemplary scoped hierarchical data set 300 representing a media collection, such as a library of multimedia content that may be available to a user on a computer system. The media collection in this example contains several forms of media, including music and photos, as well as organizational groupings of such media, including photo albums, playlists, and music sets. These different forms of data may be conceptually related, and may be associated as a hierarchical scope, such as the exemplary set of associations illustrated in the table 270 of FIG. 5A. In this example, one hierarchical scope 302 may be used to group photos with photo albums, and another hierarchical scope 304 may be used to group playlists with music sets. Moreover, since each hierarchical scope in this example represents similar data, each hierarchical scope may be associated with a viewer, such as a particular software application capable of displaying the types of data associated with the hierarchical scope.

Associating a hierarchical scope with a viewer may facilitate user interaction with the hierarchical data set. FIG. 5C illustrates the scoped treeviews 310 for each node in the scoped hierarchical data set 300 of FIG. 5B and the related applications. As in the preceding examples, selecting each node of the hierarchical data set presents the associated scoped treeview. Moreover, activating a node within the root scope of the scoped treeview causes the activated node to be displayed in a user interface component, such as a viewer, that is configured to display nodes of the type associated with this hierarchical scope. For example, selecting the “Photo Album 2” node 312 presents a scoped treeview of “Photo Album 2” 314, “Photo 1” 316, and “Photo 2” 318, with “Photo Album 2” 314 being the root node. Activating any of these nodes causes the activated node to be displayed in a “Photo Viewer” 320 user interface component, such as a photo viewer application. In accordance with the implementation variation described and illustrated in FIG. 4C above, each scoped treeview omits the child nodes of nodes having a scope other than the root scope. For example, the scoped treeview 322 representing the root scope for music sets and playlists includes the node for “Playlist 2” (of the same scope) and its child node “Song 2” (of a different scope), but omits the children of child node “Song 2”, such as “Song 2 Lyrics.” This latter child node is illustrated in the scoped treeview 324 for “Song 2.”

FIG. 5D illustrates the scoped breadcrumb lists 330 for each node in the scoped hierarchical data set 300 of FIG. 5B, along with the viewer associated with each node, based on the hierarchical scope with which the node is associated. For example, activating a node representing a photo album or a photo displays the selected item in a photo viewer, whereas activating a node representing a music set or a playlist displays the music set or playlist in a music organizer application. It will again be appreciated that the user interface embodying the scoped breadcrumb lists may enable different modes of interaction with the breadcrumbs, wherein one mode comprises “selection” of the node that causes navigation to the selected node (e.g., displaying a scoped treeview for the scope of the selected breadcrumb), and wherein another mode comprises “activation” of the node that causes the activated node to be displayed in a viewer application, for example. Many such user interface arrangements may be devised by those of ordinary skill in the art and configured to operate in accordance with the techniques presented herein.

These variations of scoped treeviews and/or scoped breadcrumbs are not intended to be exhaustive; rather, many variations involving scoped treeviews and/or scoped breadcrumbs may be devised that may be present various advantages. As one example, the hierarchical scopes may be assigned names, and the name of the hierarchical scope may be displayed in a scoped treeview and/or a scoped breadcrumb list according to the name of the hierarchical scope, rather than the nodes contained therein. For example, in FIG. 5B, the hierarchical scope including the nodes “Music Set 1,” “Playlist 1,” and “Playlist 2” may be assigned the name “Music,” and this name may be displayed in the scoped treeview and/or scoped breadcrumb list instead of the nodes contained therein. For example, a scoped treeview having a root scope other than the “Music” hierarchical scope may simply display one node in the scoped treeview labeled “Music,” and may display the names of the nodes contained herein for the scoped treeviews having “Music” as the root scope. As a second example, some of the nodes comprising a first hierarchical scope may also be associated with a second hierarchical scope, such as a scope of finer granularity. Alternatively, the collapsing may toggle between or among a collapsed view of the scoped breadcrumb, an uncollapsed view of the scoped breadcrumb, and a partially collapsed view of the scoped breadcrumb, wherein the breadcrumbs comprising the second hierarchical scope are aggregated into an aggregated breadcrumb within the first hierarchical scope.

The scoped treeview and/or scoped breadcrumb list may also (individually or together) be implemented as a system, such as a system for identifying a path from a root node to a selected node in a scoped hierarchical data set. A system of this nature might comprise a memory configured to represent the scoped hierarchical data set, and a treeviewing component configured to represent a scoped hierarchical data set by generating a scoped treeview of the scoped hierarchical data set having a root representing a scope. Alternatively, a system of this nature might comprise a memory configured to represent the scoped hierarchical data set, and a breadcrumbing component configured to generate a breadcrumb list representing the path within the scoped hierarchical data set in the memory, respective nodes of a scope aggregated into a scoped breadcrumb. The scoped breadcrumb lists generated by such a system may be aggregated according to the shared hierarchical scopes of the nodes comprising the path, and may therefore comprise a more condensed breadcrumb list as compared with an unscoped breadcrumb list for the selected node. Such systems may be combined in many ways to present both a scoped treeview and a scoped breadcrumb list that, individually or together, represent the scoped hierarchical data set stored in the memory.

Systems embodying these concepts may be assembled in many variations. As one example, the treeviewing component and/or the breadcrumbing component may comprise hardware configured to generate scoped treeviews and/or scoped breadcrumb lists in accordance with these techniques, such as a field-programmable gate array (FPGA). Alternatively or additionally, the treeviewing component and/or the breadcrumbing component may comprise software instructions encoded for execution on general-purpose hardware, e.g., a desktop processor, and configured to generate scoped treeviews and/or scoped breadcrumb lists according to scoped hierarchies. Many such systems may be devised by those of ordinary skill in the art that are configured to operate in accordance with the techniques presented herein.

Other embodiments of systems implemented in accordance with the concepts described herein may include additional components. In one such embodiment, the system comprises a display component configured to display the scoped treeview and/or scoped breadcrumb list. The display component may comprise a visual display apparatus, such as (e.g.) an LCD monitor, CRT monitor, projector, or printer. The display component may also comprise an interface for communicating between the treeviewing component and/or the breadcrumbing component and the visual display apparatus, such as (e.g.) a display adapter, a video memory buffer, a software driver, and/or a visual programming interface. Also, the display component may be configured to incorporate any or several of the particular embodiments discussed hereinabove. As one example, the display component may be configured to display scoped treeviews and/or scoped breadcrumbs with distinctive visual styles, such as (e.g.) a distinctive color or shading style that is associated with the hierarchical scope represented by the scoped nodes and/or scoped breadcrumb. In another embodiment, the display component may be configured to display a scope departure control configured to navigate out of the selected scope of a scoped treeview. In yet another embodiment, the display component may be configured to display at least one breadcrumb in a collapsed view, comprising fewer than all of the nodes in the scoped breadcrumb. Many such display components may be devised by those of ordinary skill in the art in the context of systems configured to operate in accordance with the techniques presented herein.

In another set of embodiments, the system may comprise an input component, such as a keyboard or a mouse, configured to accept user input in relation to the scoped treeview and/or scoped breadcrumb list. As one example, the input component may be configured to accept user input representing activation of a treeview node and/or breadcrumb, and the display component configured to present a node within the activated treeview node and/or a node within the activated breadcrumb in a user interface component (e.g., a viewer configured to display the activated node.) Alternatively or additionally, the input component may be configured to accept user input representing activation of a scoped breadcrumb, and the display component may be configured to toggle a collapsed view of an activated scoped breadcrumb. Many such input components may be devised by those of ordinary skill in the art in the context of systems configured to operate in accordance with the techniques presented herein.

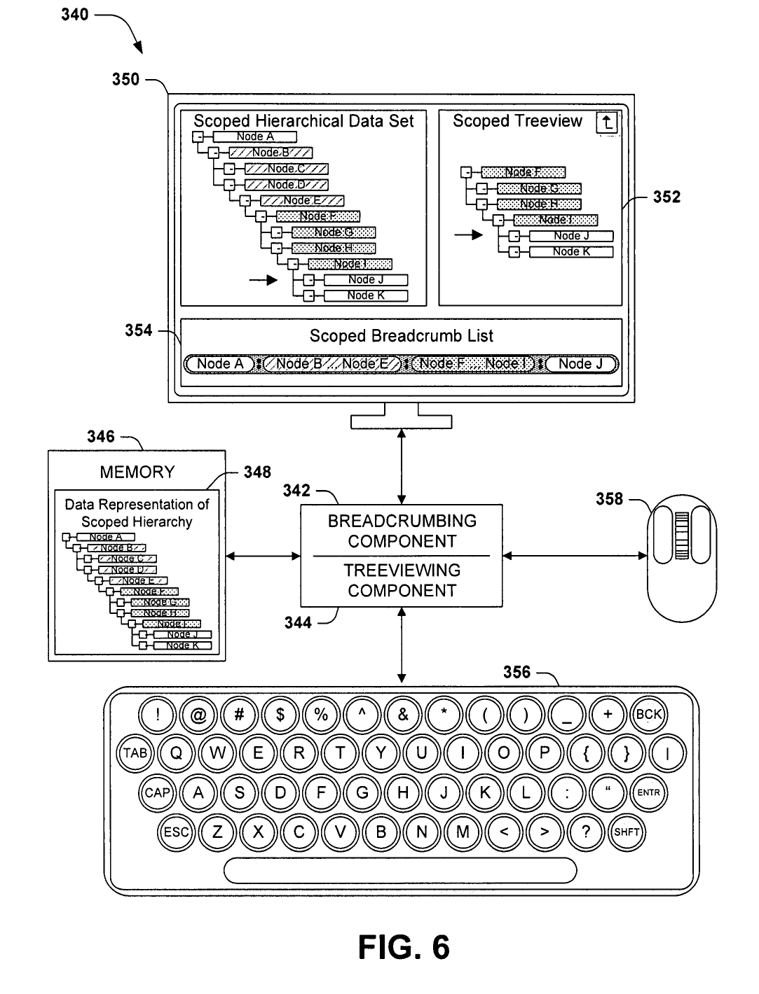

FIG. 6. illustrates an exemplary system for generating scoped treeviews and breadcrumb lists that incorporates several of the aspects described herein. In this exemplary figure, the system 340 comprises a breadcrumbing component 342 and a treeviewing component 344, each operably coupled with a memory 346 containing a data representation of the scoped hierarchical data set 348. The system 340 also comprises a display component 350 configured to display the scoped treeview 352 generated by the treeviewing component 344 and/or the scoped breadcrumb list 354 generated by the breadcrumbing component 342 for a selected node in the scoped hierarchical data set 348, 350. The system 340 also comprises two input devices, a keyboard 356 and a mouse 358, which may be configured to accept user input in relation to the scoped treeview 352 and/or scoped breadcrumb list 354. Together, these components generate and display a scoped treeview 352 and/or a scoped breadcrumb list 354 for the hierarchical data set 348, 350, and allow user interaction with the hierarchical data set 348, 350 (e.g., facilitated navigation through the nodes of the hierarchical data set 348, 350, and viewing of selected nodes in viewer applications.)

The scoped breadcrumb list may also be utilized in an integrated development environment. Graphical user interface (GUI) applications are often created within such an environment, which provides a sophisticated set of tools for designing rich user interfaces with various graphical controls, such as buttons, textboxes, and listboxes, and for writing software that interacts with the user through such controls comprising the graphical user interface. One common feature of such applications is the representation of the graphical user interface application (the “form”) as a hierarchical data set, where the root node representing the form contains the various graphical controls, which may contain other controls (e.g., a panel that contains a set of buttons) and a wide number of configurable properties. However, in recent years, the assortment of user controls has developed in sophistication and complexity. Modern integrated development environments provide programmers with many simple tools for building graphical user interface applications, such as buttons and listboxes, and also a growing assortment of more complex components, such as media players, graphical charting components, complex database interaction components, and even prepackaged neural networks. Such an integrated development environment may be configured to display one or more activated nodes of a hierarchical data set, for example (e.g., any of the constituent elements of the user interface, or the properties thereof) in an editor appropriate for the type of node selected. For example, activating a button in a hierarchical data set might display the properties of that button in a “button properties” editor.

As the variety and complexity of components that may comprise a graphical user interface application have developed, the hierarchical data set of information describing the assortment and details of such controls to the programmer has also grown in size. The programmer may have difficulty navigating through the expansive hierarchical data set while designing the application. Even the use of a treeview and breadcrumb list may not facilitate efficient navigation, as controls and properties may be located several levels deep in the hierarchical data set, thereby requiring extensive navigation within the treeview to reach a desired node, as well as a cumbersome breadcrumb list to describe the object (e.g., a breadcrumb list for a graphical user interface of “Application Form : Controls: Media Player: Media Control Panel: Progress Slider: Scrollbar”—six nested nodes deep, and hence six unscoped breadcrumbs—might be necessitated to describe the progressive scrollbar in a media player application.) Alternatively, hierarchical scopes may be applied to the hierarchical data set of graphical user interface components, and a selected node may be described by generating and displaying a scoped treeview and/or a scoped breadcrumb list (e.g., “Application Form, Controls: Media Player, Media Control Panel : Progress Slider. Scrollbar” requires only three scoped breadcrumbs.)

Accordingly, hierarchical scopes may be applied to the hierarchical data set that associatively group some conceptually relate sets of objects in the hierarchical data set (e.g., the data set representing the components and properties that comprise a graphical user interface application.) As one example, a hierarchical scope may be applied for associatively grouping the elements of a “control template,” e.g., the elements that comprise a control (e.g., a media player component may be defined by a control template specifying a Stop button, a Play button, a progress bar, etc.) As another example, a hierarchical scope may be applied for logically grouping the properties comprising a “control style,” e.g., the collection of properties defining a visual style to be applied to one or more graphical components (e.g., the font, font style, background color, and border color applied to a graphical user control.) As a third example, a hierarchical scope may be applied for logically grouping the elements of a “root scene,” e.g., the root node representing the graphical user interface application and its properties (e.g., its default style.) By applying these hierarchical scopes to the hierarchical data set defining the structure of the graphical user interface application under development, the integrated development environment may facilitate efficient navigation through the elements of the application via scoped breadcrumb lists. Thus, the integrated development environment may embody a method of representing a scoped hierarchical data set representing at least one user interface component in the integrated development environment, where the method comprises generating a first scoped treeview of the scoped hierarchical data set having a root representing a scope. Alternatively or additionally, an integrated development environment may embody a method of displaying a path from a root node to a selected node in a scoped hierarchical data set representing at least one user interface component in the integrated development environment, where the method comprises generating a breadcrumb list representing the path, and where respective nodes of a scope aggregated into a scoped breadcrumb.

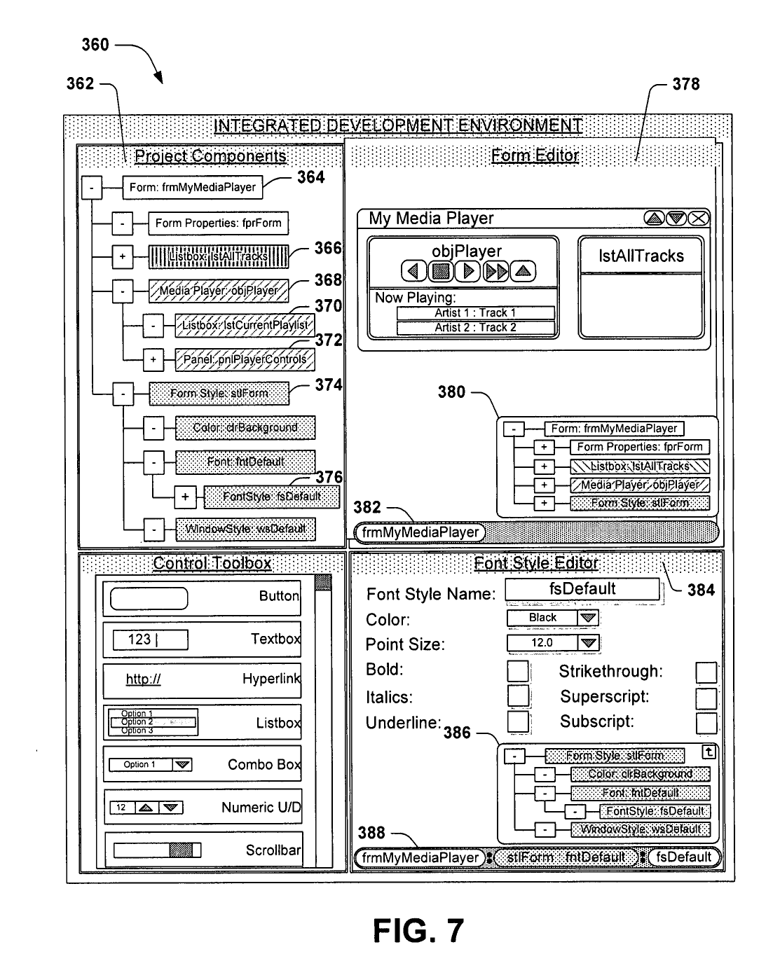

FIG. 7 illustrates an exemplary integrated development environment 360 that features scoped treeviews and scoped breadcrumb lists for navigating through the complex elements that define a graphical user interface application. The exemplary integrated development environment 360 is illustrated during its use for creating a media player application. The elements of the application are shown as hierarchical nodes displayed in a treeview 362, and various hierarchical scopes are illustrated for grouping conceptually related nodes. For example, the root node 364 of the hierarchical data set 362 represents the form, e.g., the class comprising the graphical user interface application and containing all of the graphical user controls within the application. The root node 364 contains a few controls, such as IstAllTracks 366 and objPlayer 368, each of which is designed with a “control template” scope that conceptually couples each control with some of the sub-controls embedded in it. For example, “objPlayer” 368 (an instance of a media player component) shares a hierarchical scope with two sub-controls that the media player component contains: a listbox 370 displaying the currently playing tracks, and a panel containing some media playing controls 372 (Reverse, Stop, Play, Fast-Forward, and Eject.) The root node 364 also contains a set of nested properties 374 describing the default visual style of the form 364, and a hierarchical scope is applied to some of the nested properties contained therein, such as the style of the font 376. As in previous examples, the hierarchical scopes in this exemplary figure are represented by distinctive visual styles (e.g., hashing for the hierarchical scopes representing control templates, and a shading for the hierarchical scopes representing control styles.)

By including these hierarchical scopes in the hierarchical data set representing the elements of the graphical user interface application, the exemplary integrated development environment 360 illustrated in FIG. 7 may generate scoped treeviews and/or scoped breadcrumb lists that facilitate navigation. In this exemplary integrated development environment 360, the developer is editing two portions of the graphical user interface application: the form 364 (named frmMyMediaPlayer) and the default font style 376 for the default visual style applied to the form and contained controls (named stIForm.) The form editor 378 displays a first scoped treeview 380 at the bottom right corner of the editor window, illustrating the selected node (frmMyMediaPlayer) and all of its child nodes (fprForm, lstAlITracks, objplayer, and stlFirm.) Since the latter three objects are members of a hierarchical scope, and therefore represent a different hierarchical scope than the root node (e.g., the unscoped node frmMyMediaPlayer), the child nodes of these three nodes (e.g., the constituent properties of these objects) are omitted from the scoped treeview 380. The form editor 378 also displays a scoped breadcrumb list 382 at the bottom of the editor window, comprising a breadcrumb representing the form 364 (e.g., the root node of the hierarchical data set 362.) Additionally, the default font style 376 is being edited in a font style editor 384, which displays a second scoped treeview 386 at the bottom right corner of the editor window. Since this scoped treeview 386 is rooted in the hierarchical scope comprising stlForm and its constituent properties (clrBackground, fntDefault, etc.), the treeview 386 is rooted in the hierarchical scope for stlForm, and therefore omits all of the nodes above this hierarchical scope (frmMyMediaPlayer, fprForm, lstAllTracks, etc.) The form editor 384 also displays a scoped breadcrumb list 388 at the bottom of the editor window. This breadcrumb list 388 comprises three breadcrumbs, including a scoped breadcrumb aggregating the nodes associated with the “control style” hierarchical scope. It will now be apparent that this scoped hierarchical data set 362 enables the generation of scoped treeviews and condensed breadcrumb lists that logically group related nodes and consume less space in the integrated development environment 360.

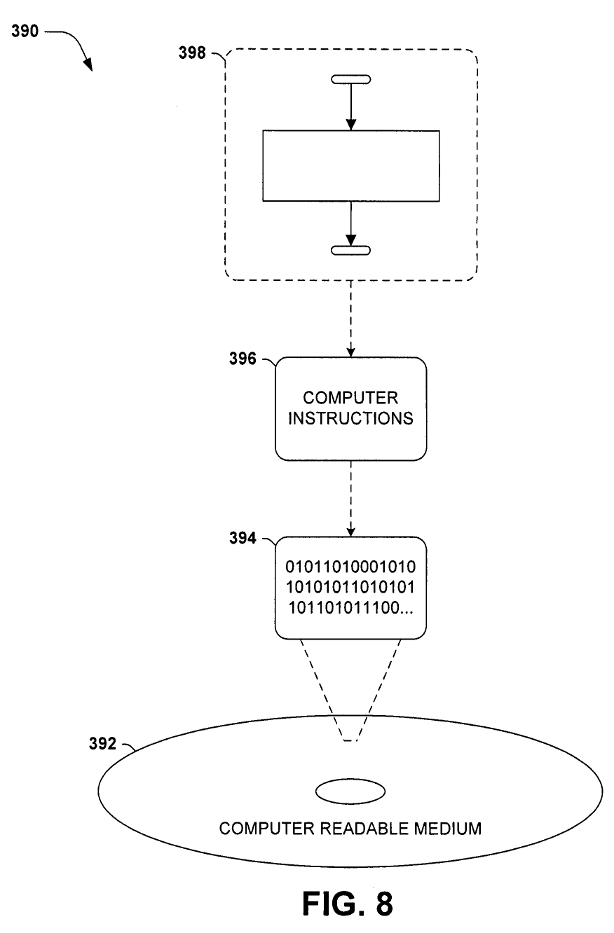

The techniques discussed herein may also be embodied as a computer-readable medium comprising processor-executable instructions configured to generate breadcrumb lists as discussed herein. An exemplary computer-readable medium that may be devised in these ways is illustrated in FIG. 8, wherein the implementation 390 comprises a computer-readable medium 392 (e.g., a CD-R, DVD-R, or a platter of a hard disk drive), on which is encoded computer-readable data 394. This computer-readable data 394 in turn comprises a set of computer instructions 396 configured to operate according to the principles set forth herein. In one such embodiment, the processor-executable instructions 396 may be configured to perform a method of representing a scoped hierarchical data set, such as the method 50 illustrated in the flowchart of FIG. 2A, and/or a method of identifying a path from a root node to a selected node in a scoped hierarchical data set, such as the method 60 illustrated in the flowchart of FIG. 2B. In another such embodiment, the processor-executable instructions 396 may be configured to implement a system for representing a scoped hierarchical data set and/or for identifying a path from a root node to a selected node in a scoped hierarchical data set, such as the system illustrated in the component diagram of FIG. 6. In yet another such embodiment, the processor-executable instructions 396 may be configured to implement a method of representing a scoped hierarchical data set representing at least one user interface component in an integrated development environment, and/or of displaying a path from a root node to a selected node in such a hierarchical data set, such as the designer illustrated in FIG. 7. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . .), smart cards, and flash memory devices (e.g., card, stick, key drive . . . ). Additionally it may be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of identifying a path from a root node to a selected node in a scoped hierarchical data set, the path having at least one scope, the method comprising:
generating a breadcrumb list representing the path, respective nodes of a scope aggregated into a scoped breadcrumb.

2. The method of claim 1, comprising:
displaying the breadcrumb list.

3. The method of claim 2, respective hierarchical scopes associated with a distinctive visual style, and the displaying comprising: displaying at least one scoped breadcrumb according to the visual style of the hierarchical scope of the scoped breadcrumb.

4. The method of claim 3, the distinctive visual style of the hierarchical scope comprising a color.

5. The method of claim 2, at least one scoped breadcrumb displayed in a collapsed view comprising fewer than all of the nodes in the scoped breadcrumb.

6. The method of claim 5, the collapsed view comprising the highest level node in the scoped breadcrumb and the lowest level node in the scoped breadcrumb.

7. The method of claim 6, the displaying comprising displaying in the collapsed view scoped breadcrumbs other than the scoped breadcrumb corresponding to the selected node.

8. The method of claim 5, comprising:
upon receiving user input representing activation of a scoped breadcrumb, toggling the collapsed view of the activated scoped breadcrumb.

9. The method of claim 2, comprising:
upon receiving user input representing activation of a breadcrumb, presenting a node within the activated breadcrumb in a user interface component.

10. The method of claim 9, the user interface component comprising:
a viewer configured to display the node within the activated breadcrumb.

11. A computer-readable medium comprising processor-executable instructions configured to perform the method of claim 1.

12. A system for identifying a path from a root node to a selected node in a scoped hierarchical data set, the path having at least one scope, the system comprising:
a memory configured to represent the scoped hierarchical data set, and
a breadcrumbing component configured to generate a breadcrumb list representing the path within the scoped hierarchy in the memory, respective nodes of a scope aggregated into a scoped breadcrumb.

13. The system of claim 12, comprising:
a display component configured to display the breadcrumb list.

14. The system of claim 13, the display component configured to display at least one scoped breadcrumb in a collapsed view comprising fewer than all of the nodes in the scoped breadcrumb.

15. The system of claim 14, comprising:
an input component configured to accept user input representing activation of a scoped breadcrumb, and the display component configured to toggle the collapsed view of the activated scoped breadcrumb.

16. The system of claim 12, comprising:
an input component configured to accept user input representing activation of a breadcrumb, and the display component configured to present a node within the activation breadcrumb in a user interface component.

17. The system of claim 16, the user interface component comprising:
a viewer configured to display the node within the activated breadcrumb.

18. A computer-readable medium comprising processor-executable instructions configured to implement the system of claim 12.

19. A method of displaying a path from a root node to a selected node in a scoped hierarchical data set representing at least one user interface component in an integrated development environment, respective scopes in the scoped hierarchical data set comprising one of a control style, a control template, and a root scene, the method comprising:
generating a breadcrumb list representing the path, respective nodes of a scope aggregated into a scoped breadcrumb.

20. A computer-readable medium comprising processor-executable instructions configured to perform the method of claim 19.
